(19) United States
(12) Patent Application Publication
(10) Pub. No.: US 2025/0307719 A1
(43) Pub. Date: Oct. 2, 2025

(54) SEAT RESERVATION SYSTEM AND SEAT RESERVATION METHOD

(71) Applicant: TOYOTA JIDOSHA KABUSHIKI KAISHA, Toyota-shi Aichi-ken (JP)

(72) Inventors: Hiroya CHIBA, Fuji-shi Shizuoka-ken (JP); Rika OIKE, Shizuoka-shi Shizuoka-ken (JP)

(73) Assignee: TOYOTA JIDOSHA KABUSHIKI KAISHA, Toyota-shi Aichi-ken (JP)

(21) Appl. No.: 19/043,560

(22) Filed: Feb. 3, 2025

(30) Foreign Application Priority Data
Mar. 26, 2024 (JP) 2024-049823

(51) Int. Cl. G06Q 10/02

(52) U.S. Cl. CPC G06Q 10/02

(57) ABSTRACT

A processor of a seat reservation system is configured to: when there is no vacant seat common throughout a use route of a first user, transmit to a second user who has reserved a same seat throughout one or more sections same as those of an entire use route of the first user, a first request for reservation transfer of the same seat to the first user; when an acceptance of the second user for the first request is not received, transmit to at least two third users who satisfy the use route, a second request for reservation transfer of seats of the at least two third users to the first user; and when an acceptance of each of the at least two third users for the second request is received, change a reservation holder of the seats of the at least two third users to the first user.

### CROSS-REFERENCES TO RELATED APPLICATION

The present disclosure claims priority under 35 U.S.C. § 119 to Japanese Patent Application No. 2024-049823, filed on Mar. 26, 2024, which is incorporated herein by reference in its entirety.

### BACKGROUND

### Technical Field

The present disclosure relates to a seat reservation system and a seat reservation method for managing seat reservations of a passenger vehicle.

### Background Art

JP 2001-312613 A discloses a reservation service system for reserved seat tickets for passenger transportation. When a first user inputs a cancellation waiting condition for a specific flight, the reservation service system presents a reward and a substitute flight to a second user who has reserved the specific flight. When the second user designates a flight in response to this presentation, the reservation service system provides the second user with a reward and a reserved seat ticket for the changed flight, and issues a reserved seat ticket for the specific flight to the first user.

Moreover, J P 2016-024696 A discloses a reservation management system that reserves a seat preferentially from a reservation waiting for cancellation. Furthermore, J P 2003-076903 A discloses a seat reservation system. When a first seat is reserved, the seat reservation system places the first seat and seats in front, rear, left, and right of the first seat on a waiting list, and temporarily reserves one of seats which are vacant at another date and time among the first seat and the seats in front, rear, left, and right of the first seat.

### SUMMARY

According to the technique described in JP 2001-312613 A, when there is no second user who matches the cancellation waiting condition, the first user who waits for cancellation needs to give up using the passenger transportation or input a condition that is more concessional than the cancellation waiting condition, for example. As described above, the technique described in JP 2001-312613 A has room for improvement in that the convenience of the first user waiting for cancellation is further improved.

A seat reservation system according to the present disclosure manages seat reservations for a passenger vehicle. The seat reservation system includes one or more memory devices and one or more processors. The one or more memory devices are configured to store seat reservation information indicating a seat reservation status of each users for individual sections traveled by a target passenger vehicle in which a first user desires to board, and use route information indicating a use route that is of each of users including a first user and includes a plurality of sections traveled by the target passenger vehicle. The one or more processors are configured to execute a seat management process based on the seat reservation information and the use route information. In the seat management process, the one or more processors are configured to: when there is no vacant seat common throughout the use route of the first user, transmit to a user device of a second user who has reserved a same seat throughout one or more sections same as those of an entire use route of the first user, a first request for reservation transfer of the same seat to the first user; when an acceptance of the second user for the first request is not received within a designated time, transmit to respective user devices of at least two third users who satisfy the use route of the first user when one or more sections reserved by each of the at least two third users are combined, a second request for reservation transfer of seats of the at least two third users to the first user; and when an acceptance of each of the at least two third users for the second request is received within a designated time, change a reservation holder of the seats of the at least two third users to the first user.

A seat reservation method according to the present disclosure manages seat reservations for a passenger vehicle. The seat reservation method, which is executed by a computer, includes executing a seat management process based on seat reservation information indicating a seat reservation status of each users for individual sections traveled by a target passenger vehicle in which a first user desires to board, and use route information indicating a use route that is of each of users including a first user and includes a plurality of sections traveled by the target passenger vehicle. The seat management process includes: when there is no vacant seat common throughout the use route of the first user, transmitting to a user device of a second user who has reserved a same seat throughout one or more sections same as those of an entire use route of the first user, a first request for reservation transfer of the same seat to the first user; when an acceptance of the second user for the first request is not received within a designated time, transmitting to respective user devices of at least two third users who satisfy the use route of the first user when one or more sections reserved by each of the at least two third users are combined, a second request for reservation transfer of seats of the at least two third users to the first user; and when an acceptance of each of the at least two third users for the second request is received within a designated time, changing a reservation holder of the seats of the at least two third users to the first user.

According to the present disclosure, when there is no vacant seat common throughout the use route of the first user, first, the first request is transmitted to the second user who has reserved the same seat throughout one or more sections same as those of the entire use route. Then, when there is no acceptance of the second user for this first request, the second request is transmitted to at least two third users who have reserved seats satisfying the use route. By requesting reservation transfer of a seat while changing the target of the request in a stepwise manner in this way, it is possible to increase the possibility that the first user obtains a seat for the use route. This leads to improvement in convenience of the first user waiting for cancellation.

### BRIEF DESCRIPTION OF THE DRAWINGS

FIG. 1 is a diagram schematically showing an example of a configuration of a seat reservation system according to an embodiment;

FIG. 2 is a flowchart illustrating a first example of a seat management process according to an embodiment;

FIG. 3 is a supplementary diagram used to describe processes of steps S116 to S120 shown in FIG. 2;

FIG. 4 is a flowchart illustrating a second example of the seat management process according to an embodiment; and

FIG. 5 is a diagram showing an example of a seat reservation status of a passenger vehicle which is referred to for description of a calculation method of a movement burden score.

### DETAILED DESCRIPTION

Embodiments of the present disclosure will be described with reference to the accompanying drawings.

### 1. Configuration of Seat Reservation System

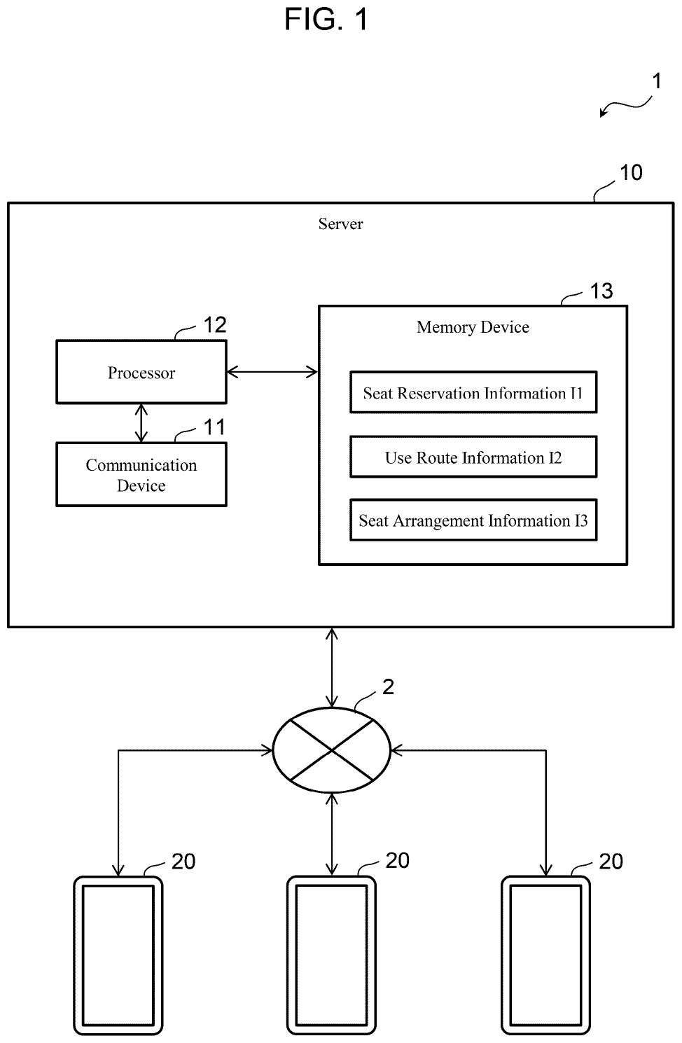

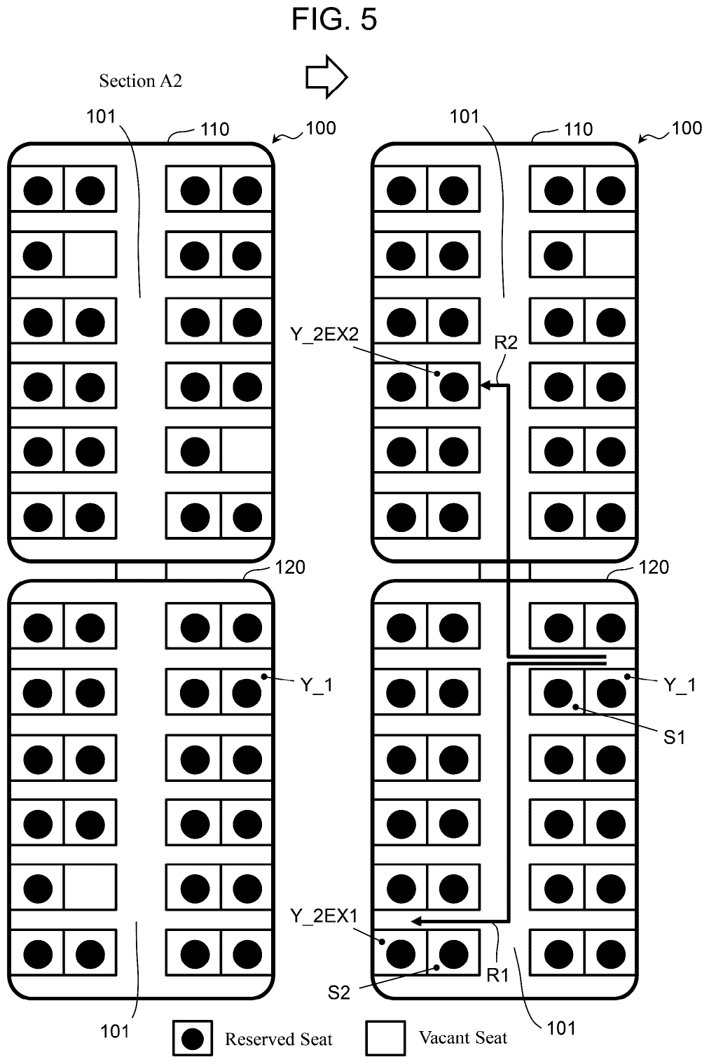

FIG. 1 is a diagram schematically showing an example of a configuration of a seat reservation system 1 according to an embodiment. The seat reservation system 1 manages seat reservations of a passenger vehicle. The passenger vehicle has a plurality of seats to be reserved by a plurality of users U. The passenger vehicle may be a single car or may be configured by coupling two or more cars (e.g., a passenger vehicle 100 shown in FIG. 5). Examples of the latter include an articulated bus and a train.

The seat reservation system 1 includes, for example, a server 10 and a user device 20 operated by each user U.

The server 10 includes a communication device 11, one or more processors 12 (hereinafter, simply referred to as a processor 12), and one or more memory devices 13 (hereinafter, simply referred to as a memory device 13).

The communication device 11 is configured to communicate with the user device 20 of each user U via a communication network 2.

The processor 12 executes various processes related to the seat reservation of the user U, which will be described below. Examples of the processor 12 include a central processing unit (CPU), a graphics processing unit (GPU), an application specific integrated circuit (ASIC), and a field-programmable gate array (FPGA). The processor 12 may also be referred to as circuitry or processing circuitry.

The memory device 13 stores various kinds of information. Examples of the memory device 13 include a volatile memory, a nonvolatile memory, a hard disk drive (HDD), and a solid state drive (SSD). The functions of the server 10 may be implemented by cooperation between the processor 12 that executes a management program and the memory device 13. The management program is stored in the memory device 13. Alternatively, the management program may be recorded in a computer-readable recording medium. The management program may be provided via a network.

The various kinds of information includes seat reservation information I1 and use route information 12. The various kinds of information may also include seat arrangement information I3.

The seat reservation information I1 indicates a seat reservation status of each user U for individual sections traveled by the passenger vehicle, and includes information on vacant seats in the individual sections and information on reserved seats in the individual sections. The individual sections mentioned here include sections between two adjacent stops or stations. The seat reservation information I1 is stored for each passenger vehicle. The seat reservation information I1 is appropriately updated depending on the status of seat reservations (including reservation cancellations) by each user U.

The use route information 12 indicates a use route that is used by each user U of the passenger vehicle and includes a plurality of sections traveled by the passenger vehicle. The user U who wants to reserve a seat of a passenger vehicle operates the user device 20 to transmit seat request information 10 to the server 10. The seat request information I0 includes, for example, a desired passenger vehicle and desired use route of the user U. For example, when receiving the seat request information 10 from the user device 20 operated by the user U, the server 10 stores the desired use route, which is included in the seat request information 10, in the memory device 13 as the use route information 12. The use route information 12 is also stored for each passenger vehicle.

The seat arrangement information 13 indicates the arrangement of seats provided in the passenger vehicle that is a target of the seat reservation by each user U. The memory device 13 stores the seat arrangement information 13 of each passenger vehicle whose seat reservation is managed by the server 10.

The user device 20 is a communication terminal operated by the user U. The user device 20 is, for example, a mobile device such as a smartphone carried by the user U. More specifically, the user device 20 includes an input unit that receives an operation of the user U and an output unit that displays information to the user U.

### 2. Seat Management Process

It is desired to appropriately improve the convenience of the user U (first user U1) who waits for cancellation of a seat reservation of a passenger vehicle (target passenger vehicle) that the user U desires to board. Therefore, in the present embodiment, the processor 12 of the server 10 executes a “seat management process” as follows based on the seat reservation information I1 and the use route information I2.

That is, when there is no vacant seat common throughout the entire use route Z of the first user U1 that includes a plurality of sections traveled by the target passenger vehicle, the processor 12 transmits to the user device 20 of a second user U2 that has reserved the same seat X throughout one or more sections same as those of the entire use route Z of the first user U1, a first request for reservation transfer of the same seat X to the first user U1. When the processor 12 does not receive an acceptance of the second user U2 for this first request within a designated time, the processor 12 transmits to the respective user devices 20 of at least two third users U3_i (i=1 to N (N≥2)) who satisfy the use route Z when one or more sections reserved by each of the at least two third users U3_i are combined, a second request for reservation transfer of seats Y_i of the at least two third users U3_i to the first user U1. Then, when an acceptance of each of the at least two third users U3_i for the second request is received within a designated time, the processor 12 changes the reservation holder of the seats Y_i of the at least two third users U3_i to the first user U1.

### 2-1. First Example

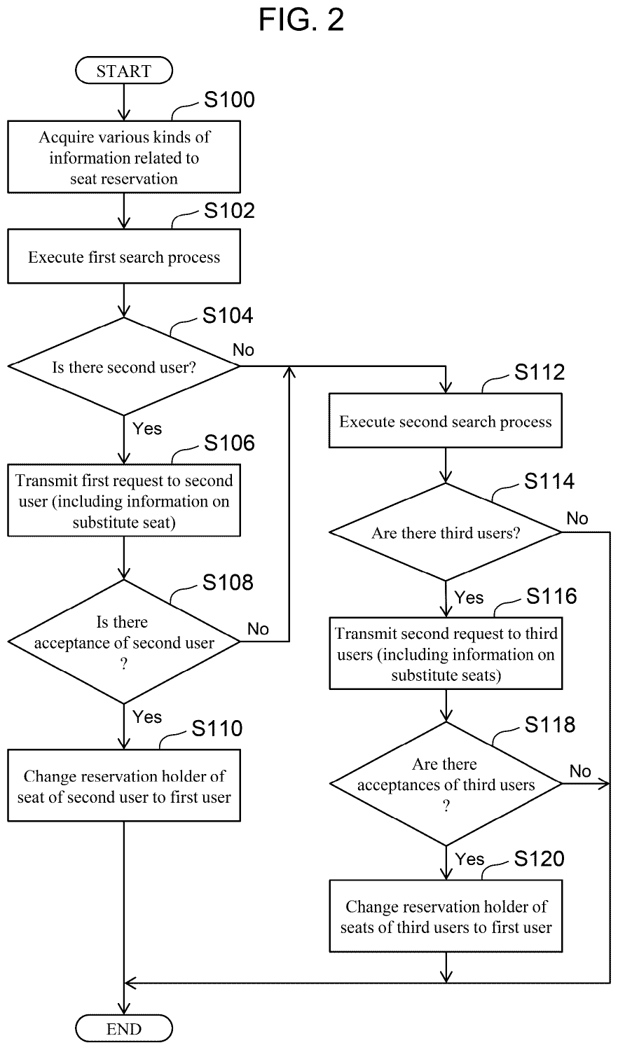

FIG. 2 is a flowchart illustrating a first example of the seat management process according to the embodiment. The processing of this flowchart is executed when there is no vacant seat common throughout the entire use route Z including a plurality of sections in response to a request for a seat reservation from the first user U1 for the use route Z.

In step S100, the processor 12 acquires the seat reservation information I1 and the use route information 12 from the memory device 13. The use route information I2 includes information on the use route of the first user U1. Thereafter, the processing proceeds to step S102.

In step S102, the processor 12 executes a first search process. To be specific, the processor 12 searches for a second user U2 who has reserved the same seat X throughout one or more sections same as those of the entire use route Z of the first user U1 based on the seat reservation information I1 and the use route information 12 acquired in step S100. Thereafter, the processing proceeds to step S104.

In step S104, the processor 12 determines whether or not the second user U2 who has reserved the same seat X described above is found. As a result, when the second user U2 is found (step S104; Yes), the processing proceeds to step S106.

In step S106, the processor 12 transmits to the user device 20 of the second user U2, a first request for reservation transfer of the same seat X to the first user U1. In addition, the first request transmitted in step S106 may include presenting a substitute seat to the second user U2. That is, the first request may be a request for seat exchange between the first user U1 and the second user U2. More specifically, the substitute seat mentioned here is a seat that can be reserved in another passenger vehicle for one or more sections same as those of the same seat X. The another passenger vehicle mentioned here is, for example, a passenger vehicle immediately after the target passenger vehicle for which the first user U1 is waiting for cancellation. Additionally, when the first request is transmitted, the processor 12 may make a provisional reservation for the substitute seat.

In step S108 subsequent to step S106, the processor 12 determines whether or not an acceptance of the second user U2 for the first request has been received within a designated time. As a result, when the acceptance of the second user U2 is received within the designated time (step S108; Yes), the processing proceeds to step S110.

In step S110, the processor 12 changes the reservation holder of the seat (that is, the same seat X) of the second user U2 from the second user U2 to the first user U1. More specifically, the processor 12 stores, in the memory device 13, the seat reservation information I1 updated so as to reflect the change of the reservation holder. Moreover, in an example in which the first request includes information on the substitute seat, the processor 12 changes the provisional reservation for the substitute seat to the final reservation in response to the acceptance of the second user U2. In addition, the processor 12 may perform a process for providing a reward from the first user U1 to the second user U2 who has accepted the reservation transfer of the same seat X.

On the other hand, when the second user U2 is not found (step S104; No), or when the acceptance of the second user U2 is not received within the designated time (step S108; No), the processing proceeds to step S112. In addition, in an example in which the first request includes the presentation of the substitute seat, when the acceptance of the second user U2 is not received within the designated time, the processor 12 cancels the provisional reservation for the substitute seat.

In step S112, the processor 12 executes a second search process. To be specific, the processor 12 searches for “two third users U3_1 and U3_2” who satisfy the use route Z when one or more sections reserved by the respective third users U3_1 and U3_2 are combined, based on the seat reservation information I1 and the use route information 12 acquired in step S100. Thereafter, the processing proceeds to step S114.

In step S114, the processor 12 determines whether or not the third users U3_1 and U3_2 are found. As a result, when the third users U3_1 and U3_2 are found (step S114; Yes), the processing proceeds to step S116.

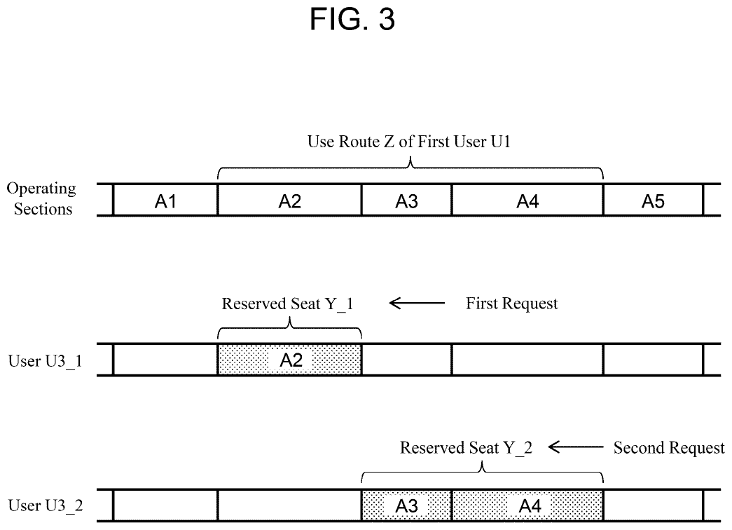

FIG. 3 is a supplementary diagram used to describe processes of steps S116 to S120 shown in FIG. 2. FIG. 3 illustrates sections A1 to A5 included in sections traveled by the target passenger vehicle (i.e., the operating sections of the target passenger vehicle). In this example, the use route Z of the first user U1 includes the sections A2 to A4. Also, in this example, a section reserved by the third user U3_1 is the section A2, and sections reserved by the third user U3_2 are the sections A3 and A4. Therefore, the combination of the section A2 and the sections A3 and A4 that are reserved by the third users U3_1 and U3_2 satisfies the use route Z.

Additionally, FIG. 3 illustrates an example in which the section reserved by the third user U3_1 is only the section A2 included in the use route Z of the first user U1. However, the section reserved by the third user U3_1 as a target of the second request is not limited to the section A2 as long as it includes one or more sections included in the use route Z. Therefore, the section reserved by the third user U3_1 may include, for example, the section A1 together with the section A2. This is the same for the third user U3_2, and the section reserved by the third user U3_2 may include, for example, the section A5 together with the sections A3 and A4.

In step S116, the processor 12 transmits to the respective user devices 20 of the third users U3_1 and U3_2, a second request for reservation transfer of seats Y_1 and Y_2 of the third users U3_1 and U3_2 to the first user U1. Similar to the first request, the second request transmitted in step S116 may include presenting a substitute seat to each of the third users U3_1 and U3_2. That is, the second request may be a request for seat exchange between the first user U1 and the third users U3_1 and U3_2. More specifically, in the example illustrated in FIG. 3, a seat of another passenger vehicle for the section A2 for the third user U3_1 and a seat of another passenger vehicle for the sections A3 and A4 for the third user U3_2 correspond to the substitute seats mentioned here. In addition, when the second request is transmitted, the processor 12 may make a provisional reservation for the substitute seats.

In step S118 subsequent to step S116, the processor 12 determines whether or not the acceptance of each of the third users U3_1 and U3_2 for the second request has been received within a designated time. As a result, when the acceptance is received within the designated time (step S118; Yes), the processing proceeds to step S120.

In step S120, the processor 12 changes the reservation holder of the reserved seats Y_1 and Y_2 of the respective third users U3_1 and U3_2 from the third users U3_1 and U3_2 to the first user U1. More specifically, the processor 12 stores, in the memory device 13, the seat reservation information I1 updated so as to reflect the change of the reservation holder. Moreover, in an example in which the second request includes information on the substitute seats, in response to the acceptance of each of the third users U3_1 and U3_2, the processor 12 changes the provisional reservation for the substitute seats to the final reservation. In addition, the processor 12 may perform a process for providing a reward from the first user U1 to each of the third users U3_1 and U3_2 who have accepted the reservation transfer of the seats Y_1 and Y_2.

On the other hand, when the third users U3_1 and U3_2 are not found (step S114; No), or when the acceptance of each of the third users U3_1 and U3_2 is not received within the designated time (step S118; No), the processing may proceed to END as illustrated in FIG. 2, or the processor 12 may execute the following processing.

That is, the processor 12 may search for “three or more third users U3_i” who satisfy the use route Z when one or more sections reserved by each of the three or more third users U3_i are combined, based on the seat reservation information I1 and the use route information 12. Then, the same processes as those of steps S114 to S120 may be executed for the three or more third users U3_i. Additionally, the maximum value of the number of the three or more third users U3_i to be searched is the same as the number of the plurality of sections included in the use route Z of the first user U1.

Alternatively, the processor 12 may search for “three third users U3_1, U3_2, and U3_3” who satisfy the use route Z when one or more sections reserved by each of the three users U3_1, U3_2, and U3_3 are combined, based on the seat reservation information I1 and the use route information 12. Then, the same processes as those of steps S114 to S120 may be executed for the three third users U3_1, U3_2, and U3_3. Further, this kind of processes may be repeatedly executed while the number of the third users U3_i is increased one by one as necessary.

Furthermore, the processing of the flowchart shown in FIG. 2 may be modified and executed as follows. That is, the processor 12 may execute a process of searching for “at least two third users U3_i” who satisfy the use route Z when one or more sections reserved by each of the at least two third users U3_i are combined, based on the seat reservation information I1 and the use route information 12, instead of the process of step S112. Then, the same processes as those of steps S114 to S120 may be executed for the at least two third users U3_i.

Additionally, in an example in which the second request includes the presentation of the substitute seats, when the acceptance of each of the third users U3_1 and U3_2 is not received within the designated time, the processor 12 cancels the provisional reservation for the substitute seats.

### 2-2. Second Example

There may be a plurality of combinations of seats Y_i of at least two third users U3_i that satisfy the use route Z of the first user U1. When the first user U1 gets on a target passenger vehicle and moves between a plurality of seats Y_i, the magnitude of the burden on the first user U1 regarding the movement may differ depending on the combination of the plurality of seats Y_i. To be specific, when a user U, such as the first user U1, moves between seats in a passenger vehicle, such as a bus or a train, the user U may need to request another user who is seated on the user U's own flow line to temporarily change his/her posture or temporarily leave his/her seat. This imposes a psychological burden on the user U who moves between the seats. Further, even if the movement distance between the seats is short, a movement between cars of the passenger vehicle that is a connected vehicle, such as a train, may be a psychological burden on the user U as compared to a movement within the same car having a long movement distance.

Therefore, in the second example of the seat management process, when there are a plurality of combinations of seats Y_i of at least two third users U3_i that satisfy the use route Z of the first user U1, the processor 12 calculates, for each of the plurality of combinations, a movement burden score SCR indicating the magnitude of the burden of the movement of the first user U1 between the plurality of seats Y_i, based on the seat arrangement information 13 and the seat reservation information I1 (score calculation process). Then, the processor 12 transmits the second request in order from a combination having the lowest movement burden score SCR among the plurality of combinations.

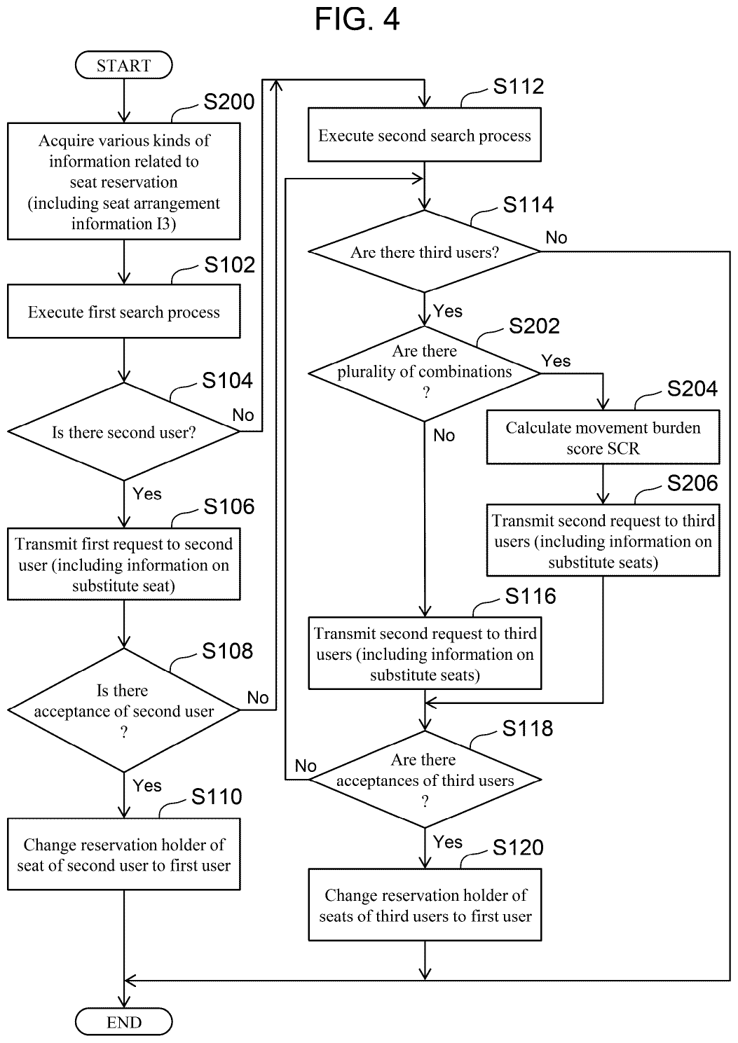

FIG. 4 is a flowchart illustrating the second example of the seat management process according to the embodiment. The processing of this flowchart is different from the processing of the flowchart shown in FIG. 2 in the following points.

To be specific, in FIG. 4, first, in step S200 instead of step S100, the processor 12 acquires the seat arrangement information 13 described above together with the seat reservation information I1 and the use route information I2.

Moreover, in FIG. 4, when the third users U3_1 and U3_2 are found (step S114; Yes), the processing proceeds to step S202. In step S202, the processor 12 determines whether or not a plurality of combinations of the third users U3_1 and U3_2 (in other words, a plurality of combinations of two seats Y_1 and Y_2) are found. As a result, when a plurality of combinations are found (step S202; Yes), the processing proceeds to step S204. On the other hand, when a plurality of combinations are not found (step S202; No), the processing proceeds to step S116.

In step S204, the processor 12 calculates a movement burden score SCR of each of the plurality of combinations based on the seat arrangement information 13 and the seat reservation information I1. The process of step S204 corresponds to the score calculation process. To be specific, the processor 12 calculates a movement burden score SCR of each of the plurality of combinations by adding up individual scores SCR_i (i=1 to M) of a plurality of factors related to the burden of the movement of the first user U1 between the seats Y_1 and Y_2.

FIG. 5 is a diagram showing an example of a seat reservation status of a passenger vehicle 100 which is referred to for the description of the calculation method of the movement burden score SCR. Here, as an example of the use route Z of the user U, the same sections A2, A3, and A4 as those illustrated in FIG. 3 are used. FIG. 5 illustrates an example of a reservation status of each of the sections A2 and A3 when the first user U1 makes a seat reservation. The passenger vehicle 100 in the example shown in FIG. 5 is a train configured by coupling two cars 110 and 120. In FIG. 5, seats marked with black circles indicate seats reserved by other users U, and seats not marked with black circles indicate vacant seats (i.e., unreserved seats).

In the example illustrated in FIG. 5, the reserved seat Y_1 of the third user U3_1 for the section A2 is located in the car 120. Further, FIG. 5 illustrates seats Y_2EX1 and Y_2EX2 which are two examples of the reserved seat Y_2 of the third user U3_2 for the section A3 together with the section A4 which is not illustrated. The seat Y_2EX1 is located in the car 120, and the seat Y_2EX2 is located in the car 110. If the first user U1 receives reservations for the seats Y_1 and Y_2 from the third users U3_1 and U3_2, the first user U1 in the passenger vehicle 100 needs to move from the seat Y_1 to the seat Y_2EX1 or Y_2EX2 when the section switches from the section A2 to the section A3 (see a moving route R1 or R2 in FIG. 5).

A first factor which is one of the “plurality of factors” described above is a number N1 of one or more reserved seats located between a seat of the movement source and an aisle of the passenger vehicle and between the aisle and a seat of the movement destination when the first user U1 moves between seats. To be more specific, in the example of the moving route R1 shown in FIG. 5, two seats S1 and S2 correspond to one or more reserved seats located (i.e., existing) between the seat Y_1 of the movement source and an aisle 101 and between the aisle 101 and the seat Y_2EX1 of the movement destination. That is, in this example, the number N1 of one or more reserved seats, which is the first factor, is 2. Further, in the example of the moving route R2, since one seat S1 corresponds to one or more reserved seats located (i.e., existing) between the seat Y_1 of the movement source and the seat Y_2EX2 of the movement destination, the number N1 of one or more reserved seats is 1. In addition, in an example in which the use route Z of the first user U1 includes three or more sections and two or more movements between seats are necessary, the number N1 of one or more reserved seats is the total value of the numbers of one or more reserved seats that exist in the respective movements between seats.

A second factor which is another one of the “plurality of factors” described above is a number N2 of movements between cars (i.e., a car-to-car movement) of the passenger vehicle which occur when the first user U1 moves between seats. To be specific, in the example of the moving route R1 shown in FIG. 5, the movement of the first user U1 is not accompanied by the car-to-car movement. Therefore, in the example of the moving route R1, the number N2 of car-to-car movements, which is the second factor, is 0. On the other hand, in the example of the moving route R2, the movement of the first user U1 is accompanied by the car-to-car movement from the car 120 to the car 110. Therefore, in the example of the moving route R2, the number N2 of car-to-car movements is 1. Moreover, in an example in which another car (not illustrated) is interposed between the car 120 and the car 110, the movement from the seat Y_1 to the seat Y_2EX2 is accompanied by a car-to-car movement from the car 120 to the another car and a car-to-car movement from the another car to the car 110. Therefore, in this example, the number N2 of car-to-car movements is 2. Furthermore, in an example in which the use route Z of the first user U1 includes three or more sections and two or more car-to-car movements are needed, the number N2 of car-to-car movements is the total value of the numbers of car-to-car movements performed in the respective movements between seats.

For example, the processor 12 may calculate an individual score SCR_1 of the first factor such that the individual score SCR_1 becomes higher when the number N1 of one or more reserved seats is larger. Also, for example, the processor 12 may calculate an individual score SCR_2 of the second factor such that the individual score SCR_2 becomes higher when the number N2 of car-to-car movements is larger.

In step S206 subsequent to step S204, the processor 12 transmits the second request in order from a combination having the lowest movement burden score SCR among the plurality of combinations. To be specific, the processor 12 first transmits the second request to the user device 20 of each of the third users U3_1 and U3_2 corresponding to the combination with the lowest movement burden score SCR.

Thereafter, when the acceptance of each of the third users U3_1 and U3_2 to which the second request has been transmitted this time is not received within the designated time (step S118; No), the processing returns to step S114. As a result, when a plurality of combinations are found again (step S202; Yes), the processing proceeds to steps S204 and S206 again. In this way, when the processing proceeds to step S206, the processor 12 transmits the second request to the user device 20 of each of the third users U3_1 and U3_2 corresponding to a combination having the next lowest movement burden score SCR after the combination corresponding to the previously transmitted second request. The same applies hereinafter.

As described above, according to the processing of the flowchart illustrated in FIG. 4, the processor 12 transmits the second request in order from the combination having the lowest movement burden score SCR among the plurality of combinations.

### 3. Effect

As described above, according to the seat reservation system 1 of the present embodiment, when there is no vacant seat common throughout the use route Z of the first user U1, first, the first request for reservation transfer of the same seat X is transmitted to the second user U2 who has reserved the same seat X throughout one or more sections same as those of the entire use route Z. When there is no acceptance of the second user U2 for this first request, the second request for reservation transfer of the seats Y_i is transmitted to each of at least two third users U3_i who satisfy the use route Z. The reservation transfer of a seat is requested while the target of the request is changed in a stepwise manner as described above. This makes it possible to increase the possibility that the first user U1 obtains a seat for the use route Z. This leads to improvement in convenience of the first user U1 waiting for cancellation.

Moreover, as described above, the first request may include presenting, to the second user U2, a substitute seat of another passenger vehicle that covers one or more sections same as those of the same seat X of the second user U2. Accordingly, the second user U2 who has transferred the seat reservation can also obtain a seat. Similarly, the second request may include presenting, to each of at least two third users U3_i, a substitute seat of another passenger vehicle that covers one or more sections same as those of each seat Y_i of the at least two third users U3_i. Accordingly, each of the third users U3_i who has transferred the seat reservation can also obtain a seat.

Furthermore, as in the second example described above, when there are a plurality of combinations of seats Y_i of at least two third users U3_i that satisfy the use route Z, the second request is transmitted in order from a combination having the lowest movement burden score SCR among the plurality of combinations. This makes it possible to provide the first user U1 waiting for cancellation with a combination of the seats Y_i with a small burden of movement between seats.

What is claimed is:

1. A seat reservation system for managing seat reservations for a passenger vehicle, comprising:
one or more memory devices configured to store seat reservation information indicating a seat reservation status of each users for individual sections traveled by a target passenger vehicle in which a first user desires to board, and use route information indicating a use route that is of each of users including a first user and includes a plurality of sections traveled by the target passenger vehicle; and
processing circuitry configured to execute a seat management process based on the seat reservation information and the use route information, wherein
in the seat management process, the processing circuitry is configured to:
when there is no vacant seat common throughout the use route of the first user, transmit to a user device of a second user who has reserved a same seat throughout one or more sections same as those of an entire use route of the first user, a first request for reservation transfer of the same seat to the first user;
when an acceptance of the second user for the first request is not received within a designated time, transmit to respective user devices of at least two third users who satisfy the use route of the first user when one or more sections reserved by each of the at least two third users are combined, a second request for reservation transfer of seats of the at least two third users to the first user; and
when an acceptance of each of the at least two third users for the second request is received within a designated time, change a reservation holder of the seats of the at least two third users to the first user.

2. The seat reservation system according to claim 1, wherein
the first request includes presenting, to the second user, a substitute seat of another passenger vehicle that covers one or more sections same as those of the same seat.

3. The seat reservation system according to claim 1, wherein
the second request includes presenting, to each of the at least two third users, a substitute seat of another passenger vehicle that covers one or more sections same as those of each seat of the at least two third users.

4. The seat reservation system according to claim 1, wherein
the one or more memory devices are configured to store seat arrangement information of the target passenger vehicle,
in the seat management process, the processing circuitry is configured to:
when there are a plurality of combinations of the seats of the at least two third users that satisfy the use route of the first user, calculate, for each of the plurality of combinations, a movement burden score indicating a magnitude of burden of movement of the first user between the seats of the at least two third users, based on the seat arrangement information and the seat reservation information; and
transmit the second request in order from a combination having a lowest movement burden score among the plurality of combinations.

5. A seat reservation method for managing seat reservations for a passenger vehicle, the seat reservation method, which is executed by a computer, comprising
executing a seat management process based on seat reservation information indicating a seat reservation status of each users for individual sections traveled by a target passenger vehicle in which a first user desires to board, and use route information indicating a use route that is of each of users including a first user and includes a plurality of sections traveled by the target passenger vehicle, wherein
the seat management process includes:
when there is no vacant seat common throughout the use route of the first user, transmitting to a user device of a second user who has reserved a same seat throughout one or more sections same as those of an entire use route of the first user, a first request for reservation transfer of the same seat to the first user;
when an acceptance of the second user for the first request is not received within a designated time, transmitting to respective user devices of at least two third users who satisfy the use route of the first user when one or more sections reserved by each of the at least two third users are combined, a second request for reservation transfer of seats of the at least two third users to the first user; and
when an acceptance of each of the at least two third users for the second request is received within a designated time, changing a reservation holder of the seats of the at least two third users to the first user.
